(19) United States
(12) Patent Application Publication
(10) Pub. No.: US 2016/0005012 A1
(43) Pub. Date: Jan. 7, 2016

(54) CONSOLIDATED PLATFORM FOR SELLING TICKETS

(71) Applicants: Alexander Goetz, Muehlhausen (DE); Guenter Pecht-Seibert, Muehlhausen (DE)

(72) Inventors: Alexander Goetz, Muehlhausen (DE); Guenter Pecht-Seibert, Muehlhausen (DE)

(21) Appl. No.: 14/325,095

(22) Filed: Jul. 7, 2014

(51) Int. Cl. G06Q 20/12; G06Q 30/06; G06Q 10/02

(52) U.S. Cl. CPC G06Q 20/123; G06Q 10/02; G06Q 30/0601

(57) ABSTRACT

A host server can cause data characterizing a plurality of digital ticket offerings for sale to be displayed on a graphical user interface of a client device. The digital ticket offerings each can have a respective registered owner and can be used by such registered owner in connection with an event. An issuer server can provide the host server with transfer parameters that must be met for the digital ticket offerings and the host server can display each digital ticket offerings upon verification that the transfer parameters for the digital ticket offering is met. The host server can receive data that includes a request to purchase one of the displayed digital ticket offerings from the client. The host server can change the registered owner of the digital ticket offering specified in the request to the purchaser upon confirmation of receipt of payment for such digital ticket offering.

### TECHNICAL FIELD

The subject matter described herein relates to ticket trading and specifically to a platform reselling and transferring of tickets.

### BACKGROUND

With sports events and other types of entertainment events, there are big challenges in the secondary ticket trading market. These challenges include sports clubs or event/concert organizers having a lack of control and predictability for ticket sales due to black markets, uncontrolled ticket prices through market speculation and several independent ticket trading platforms that the clubs have no control and often no interaction with. The disorganization of the secondary ticket market can be unfair to fans that may need to pay unreasonably high prices set by opportunists looking to make a profit on tickets that are available in the secondary market. All the while, seats at events often remain empty due to ticket holders who may not be able to attend an event in the last minute, or who do not want to spend the time trying to sell their tickets in the secondary market. The significant profits currently made in the uncontrolled secondary markets for tickets do not currently translate into revenue for the sports clubs and event/concert organizers, rather these secondary market profits go to undeserving speculators and opportunists. In fact, the majority of the profit is currently made by third party software vendors that enable the re-selling of tickets at uncontrolled prices and in an uncontrolled manner.

### SUMMARY

In one aspect, a host server can cause data characterizing a plurality of digital ticket offerings for sale to be displayed on a graphical user interface of a client device. The digital ticket offerings each can have a respective registered owner and can only be used by such registered owner in connection with an event or service. An issuer server can provide the host server with transfer parameters that must be met for the digital ticket offerings and the host server can display each digital ticket offerings upon verification that the transfer parameters for the digital ticket offering is met. The host server can receive data comprising a request to purchase one of the displayed digital ticket offerings from the client. The request can include identification information for a purchaser. The host server can change the registered owner of the digital ticket offering specified in the request to the purchaser upon confirmation of receipt of payment for such digital ticket offering. The host server can provide data comprising the digital ticket offering.

The host server providing data can include the host server transmitting data to the client device enabling the digital ticket offering to be rendered in the graphical user interface of the client device, and the host server transmitting data to the client device enabling the digital ticket offering to be physically printed, stored, or loaded into memory.

Data characterizing at least one of the plurality of digital ticket offerings for sale can be received by the host server from a selling client device prior to the displaying of the digital ticket offering on the client device. The registered owner of the digital ticket offering can initially be a seller associated with the selling client device, prior to the changing of the registered owner to the purchaser.

Data characterizing at least one of the plurality of digital ticket offerings for sale can be received by the host server from the issuer server prior to the displaying of the digital ticket offerings on the client device. The digital ticket offerings can include unsold tickets, donor tickets, or released away tickets, prior to the changing of the registered owner to the purchaser. The registered owner of the digital ticket offering, prior to the changing of the registered owner to the purchaser, can include a donor, a contingent ticket owner, or the issuer server.

The transfer parameters can be compared against parameters for each digital ticket offerings set through a selling client device. The parameters for each digital ticket offering can include a price or a promotion. The transfer parameters can include a price range window within which the digital ticket offering can be offered for sale, limitations of which promotions can be included in the ticket offering, and a duration of time that the ticket can be available be for sale.

The issuer server can control both the digital tickets offerings available for first time sale and the digital tickets offerings available for re-sale.

Changing the registered owner of the digital ticket offering to the purchaser can include sending a portion of the received payment to the issuer server.

The digital ticket offerings can include season passes, contingent digital tickets, donor ticket allotments, individual digital tickets for individual event, and promotions.

Upon receiving notification of a transition action the host server can release the digital ticket offering and can revoke the future ability to change ownership of the digital ticket offering. Therefore, only the last registered owner assigned to the digital ticket offering can exercise the right promised by the digital ticket offering.

A transition action can include printing the digital ticket offering, successful identification verification confirming that the identity of an individual attempting to enter the event corresponds with the last registered owner of the digital ticket offering, and successful verification that the client device attempting to enter an event corresponds with last registered owner of the digital ticket offering.

A successful identification verification of the identity of the individual can include cross referencing at least one of a visual check of an identity card, a finger print scan, an eye scan, or a facial recognition mapping with least one of a barcode, radio frequency identifier, printed or digital picture of the individual, or the name of the individual.

A successful verification of the client device corresponding with the last registered owner of the digital ticket offering can include using at least one of a proximity sensor, a global positioning system, validation test messaging, a subscriber identity module, or a unique identification number corresponding to the client device.

Non-transitory computer program products (i.e., physically embodied computer program products) are also described that store instructions, which when executed on one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The current subject matter provides many advantages. For example, the current subject matter provides a platform where fans can flexibly and easily re-sell their tickets for a fair price, and where the sports clubs and event/concert organizers benefit from the aftermarket sales of their tickets.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram of the system for implementing the consolidated platform for selling tickets; and

FIG. 2 is a process flow chart illustrating transfer of ownership of tickets.

### DETAILED DESCRIPTION

The subject matter described herein provides a consolidated platform for selling and trading of tickets to sporting events and other entertainment events in primary and secondary markets. In particular, provided herein is a fair and flexible trading platform by at least keeping track of tickets in the secondary market and controlling the prices of these tickets.

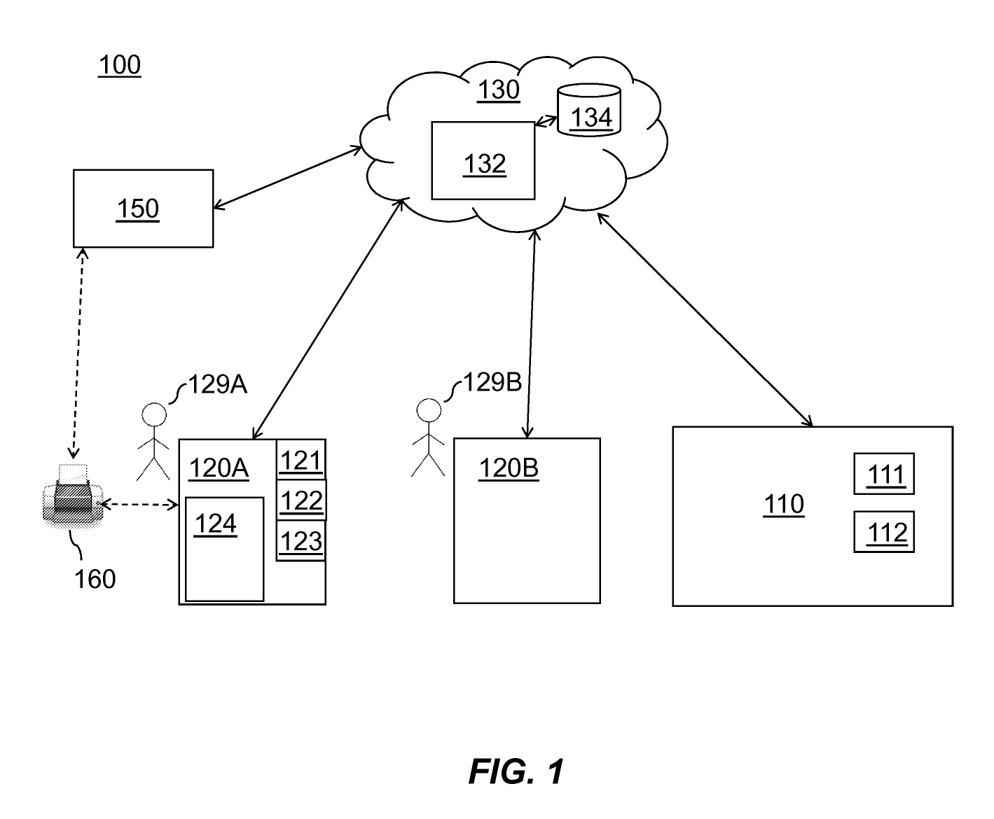

FIG. 1 is a diagram of a system 100 for implementing the consolidated platform for selling tickets. It will be appreciated that other environments can be utilized including variations of the environments illustrated in FIG. 1. The system 100 can include at least one issuer server 110, which can be a computer server used by an event organizer to make tickets available for sale, or re-sale on the ticket trading platform. The system 100 can also include at least one client device 120A, and another client device 120B, that can be in communication with a network, including a host server 130, implemented within a cloud. The host server 130 can communicate wirelessly with the client devices 120A and 120B and the at least one issuer server 110. The host server 130 can include a memory and processor for storing and processing data and information. The at least one issuer server 110 can also include at least one processor 111 and at least one memory 112.

The client device 120A can include at least one processor 121 and memory 122. The client device 120A can be a mobile device, for example a mobile phone, a tablet computer, and such, and well as a computer terminal. Additionally, the client device 120A can include sensors and other types of technology that can enable a trading device to provide location information about the individual 129A using the client device 120A. For example, the sensors 123 for confirming a ticket trader's identity and location can include a global positioning system (GPS), a proximity sensor using BLUETOOTH or other wireless technologies, a finger print scanner, a facial recognition scanner, amongst other things. Data acquired by the sensors 123, (e.g., location, verification of identity, etc.) can be collected by the processing unit 121, stored in memory 122, and sent to the host server 130. A similar description can apply to client device 120B and individual 129B using this client device.

In at least some variations, an event organizer can include a sporting club, a concert planning organization, an international sports organization like FIFA World Cup, the Olympic Games, or the like. In at least some other variations, an event organizer can include an entity issuing tickets of other sorts such as transportation tickets, including planes, trains and boat rides, as well as tickets to amusement parks, or even promotions for restaurants, vacation packages, etc. The event organizer can offer different types of ticket offerings for sale in a primary market. These ticket offerings can include season tickets, ticket contingents, and individual tickets. Ticket contingents can be tickets reserved for an away team, contingent that the away team does in fact participate in the event for which the contingent ticket is assigned. The ticket offerings can also include an allotment of tickets at no cost, reserved for donors as a form of gratitude. The event organizer can provide a list of ticket offerings, pricing and promotions, etc., via the issuer server 110, to an application 132 and database 134 on a host server 130, at which point they can be considered as digital ticket offerings, and therefore paperless ticket offerings, rather than paper based ticket offerings.

An application 132 on the host server 130 can present all, or a relevant subset of the available digital ticket offerings to potential ticket buyers via a graphical user interface 124 on the client device 120A, when the client device 120A is connected to the application 132. The client device 120A can connect to the application 132 on the host server 130 using wired or wireless networks and internet protocols including http and https, and the like. A potential ticket buyer 129A can view the available digital ticket offerings, without being a registered user of application 132. In order to purchase a specific digital ticket offering from the primary market, the potential ticket buyer 129A can be a registered user with the application 132. The registered user can begin purchasing a specific digital ticket offering from the primary market by logging into the application 132, selecting the digital ticket offerings to be purchased, and providing payment for the digital ticket offerings. The payment methods can include credit card, paypal, smart wallet, and other like payment methods. As a part of the purchasing process, the application 132 can re-assign ownership of the digital ticket offerings from the previous registered user to the registered user who purchased the digital ticket offerings. It is noted that even after the sale of the digital ticket offerings, the digital ticket offerings can remain in a digital format within the application 132 and database 134 on the host 130.

The digital ticket offerings that were purchased by the first registered user can be flexibly and easily sold, and re-sold a number of times, to other registered users on a secondary market, even up until right before the event. The client device 120A driven by the registered user 129A, can provide the application 132 and database 134 with a list of digital ticket offerings that it has available for sale to the secondary market. These digital ticket offerings available in the secondary market can be the same as the digital ticket offering sold in the primary market, or may be portions thereof. For example, a complete season pass can be sold in the secondary market, as well as individual tickets to individual games or events, from that season pass.

The application 132 and database 134 can receive digital ticket offerings to be sold on the secondary market from the client devices 120A and 120B on an ongoing basis. Additionally, application 132 and database 134 can also receive digital ticket offerings from at least one issuer server 110 to be sold on the secondary market. For example, donor ticket allotments or unused contingent tickets from away clubs can be made available for sale in the secondary market and can be sold ad hoc, right after away clubs release unused contingent tickets. This can be a great advantage, because contingent tickets from away clubs and donor allotments tickets are often not resold, and these sought after seats can remain empty on the day of the event. Additionally, unsold tickets from the primary market can be sold on the secondary market. Furthermore, the issuer server can issue new ticket offerings to be sold on the primary or secondary markets at any time up until the event. According to a preferred implementation, the event organizer can prioritize, via the issuer server 110, which tickets can be presented for sale to potential ticket buyers, ahead of other tickets. This can facilitate the scenario where sometimes the event organizers may want to sell their tickets first, before opening up the market to the re-selling of tickets in the secondary market. The application 132 can collect the digital ticket offerings, can store them in the database 134, and can present them in an organized manner to the graphical user interfaces 124 of client device 120A, in a similar manner as is described in the primary market. The event organizer, using the issuer server 110, can define transfer parameters defining the conditions for sale of the digital ticket offerings stored at the host server 130. These transfer parameters can include a price range window within which the digital ticket offering can be offered for sale, limitations on which promotions can be included in the ticket offering, the duration of time that the ticket can be available be on sale, amongst other things. The definition of parameters for the digital ticket offerings can be set through the client device, within the transfer parameter limitations as defined by the event organizer. For example, the actual price of the digital ticket offering available for re-sale must be within the price range window defined by the issuer server 110. As another example, a selling individual, via a client device, can incorporate a free shirt as a promotion included in the digital ticket offering for sale. As yet another example, a selling individual, via his client device may only be able to offer for re-sale his digital ticket offering up until three days before the event, if that is the time duration limitation defined by the issuer server 110. In this manner, the event organizer using the issuer server 110, can maintain control of the digital ticket offerings in all markets, specifically the primary and secondary markets. Additionally, special offerings from the event organizer can be presented to the user devices of users while they are attending a particular event. In this manner, marketing principles of selling at the peak of the fans' enthusiasm, can be taken advantage of.

In some variations, the event organizers can further define transfer parameters by defining additional aspects of the digital ticket offerings presented to potential buyers. These can include group offerings, promotions before and at the event, registered user prioritization, and event organization related credit points, etc. These different aspects of the ticket offerings can be provided based on membership status, accrued club related credit points, weather, an individual's proximity to an event, age, and gender, amongst other things. These transfer parameters, in the form of promotions, can be offered by the event organizers, via the host server 130, and associated with digital ticket offerings sold in the secondary market.

Potential buyers who are registered users with the application 132 can view, and purchase digital ticket offerings available on the secondary market. When the digital ticket offerings, or broken down parts thereof are sold to another registered user, the host server 130 can digitally re-assign ownership of the digital ticket offerings from the previous registered user, to the purchasing registered user. In cases where the ticket offerings sold on the secondary market can be tickets that were not previously sold (e.g. donor tickets, or new/unsold tickets), the previous registered user can be considered as a donor, or a registered user assigned to the issuer server of the contingent team.

Therefore, all selling, buying and trading activities of all trading parties can take place on the one digital consolidated platform. In this manner, the event organizers can maintain control of the digital ticket offerings and do not relinquish control to external secondary markets where the tickets can fall into the hands of black markets and opportunists. Upon the re-sale of each digital ticket offering, the event organizers can receive a portion of the payment, for example via the club server 110, thereby providing an additional revenue channel to the event organizers. By the maintaining control of digital ticket offerings in both the primary and secondary markets, the event organizers, can enable fair ticket prices to fans, can provide high and flexible digital ticket offerings availability, can offer transparency and predictability of ticket revenues in the primary and secondary ticket markets, and can secure new revenue channels to the event organizers. Furthermore, this consolidated digital trading platform can prevent ticket offerings in the secondary market from being sold in black markets and at uncontrolled prices through speculation, or on several independent ticket trading platforms without any control by the event organizers. Moreover, with the control of the digital ticket offerings remaining with the event organizers, the event organizers can refuse sales of tickets offering if required, allocate additional seating on popular events, enforce quotas dynamically for different reasons as may be required, amongst other things. By maintaining control and keeping track of the sales of digital ticket offerings, the event organizers can also decide to ad hoc sell ticket offerings at cash desks around the stadium, that may become available, for example due to last minute released ticket contingents, no-show donors, etc. In this scenario, the ability of the event organizer to prioritize its ticket sales over other ticket sales via the issuer server can be very beneficial.

In order to exercise the right that the digital ticket offering promises, a transition action can be required in order to translate the digital ticket offering into the right promised by the digital ticket offering. Examples of rights promised by a digital ticket offering can include entering an event, receiving a promotion included in the digital ticket offering, or boarding a train, amongst other things. Upon receiving notification of a successful transition action, the host server 130 can release the digital ticket offering and can revoke the ability to re-assign the digital ticket offering to another registered user. It is noted that the host server 130 releasing a digital ticket offering after a transition action is performed does not necessarily mean that a ticket has been used. For example, the host server 130 can release a digital ticket offering upon notification that the corresponding ticket was printed, but not yet used, to enter into an event.

In some variations, a transition action can include printing a ticket associated with a digital ticket offering. Upon receiving notification of the transition action, i.e. that the ticket has been printed, the host server can release the associated digital ticket offering. The notification of printing can be sent from a terminal device 150, for example in an individual's home three days prior to the event, from a ticket printer 160 at the event location, or from a client device 120A. Once the digital ticket offering is released by the host 130, it is preferable that no further digital ticket offerings re-assignments between registered users can be made, however exceptions may be made for lost tickets and another scenarios.

The right promised by the ticket can be enforced by printing onto the ticket identification information corresponding to last registered user assigned to the associated digital ticket offering. Upon attempting to exercise the ticket right, a validation checker at an event gate can enforce the right to enter the event by verifying that the identity of the individual attempting to exercise the right matches the identification on the printed ticket. An individual attempting to enter into an event can be expected to show proof to validate that he or she is in fact the individual corresponding to the name printed on the physical ticket. The validation checker can visually validate an identification card (e.g. driver's license) corresponding to the name on the printed ticket. The validation checker can also compare the facial features of the individual with a printed picture if available on the ticket. Moreover, the validation checker can cross-reference a unique identifier on the printed ticket with a biometric identifier on the individual. For example, the unique identifier can include a barcode, or radio frequency identifier on the printed ticket and the biometric identifier can be a fingerprint, an eye scan, or a facial recognition map, amongst others and retrieved using a finger print scanner, an eye scanner, or a facial recognition device, amongst other things.

In some variations, a transition action can include a verification that the client device 120A attempting to enter the event has a valid associated digital ticket offering. This transaction action can assume that it can be sufficient to validate the client device 120A, and not necessarily the individual carrying the client device 120A. In such variations, an individual can exercise the right promised by the digital ticket offering without a printed ticket. As such, examples of transition actions can be provided as follows. As a client device 120A approaches an entry gate of an event, sensors on the client device 120A or at the event location can detect the proximity of the client device 120A to the event. Such sensors can include a geo-positioning system device, a wireless proximity sensor, amongst other things. Upon detection, the client device 120A can communicate with the host 130, and can be validated as owning the relevant digital ticket offering. This transition action can be facilitated by the client device 120A logging into the host 130 as a registered user, or by a validating text message. Alternatively or additionally, identifiers unique to the client device 120A can be employed to facilitate client device 120A validation and can include a subscriber identity module (SIM), or an identification number corresponding to the client device 120A. Further examples of transition actions can include loading the digital ticket offering into the graphical user interface of the client device, and the validating and releasing the digital ticket offering by verifying a unique identifier to the ticket displayed on the client device 120A. Such as unique identifier can include a barcode.

In some variations, a transition action can include verification that the digital ticket offering shown on a client device 120A matches the identification of the individual holding the client device 120A. Such transition actions can involve using combinations of the mentioned transition actions.

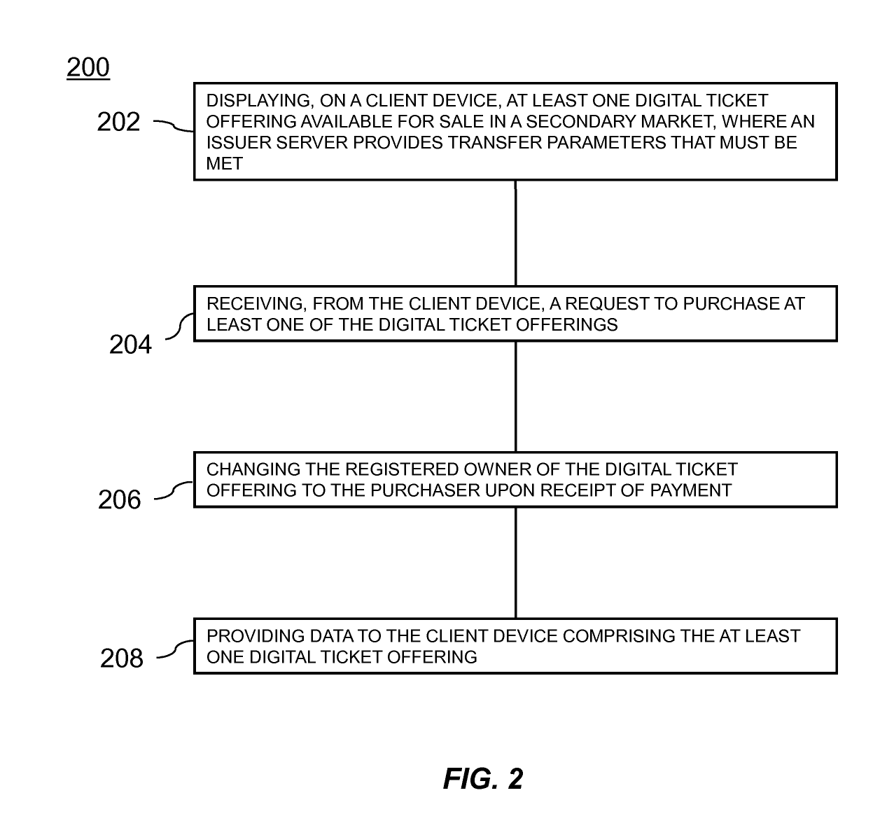

FIG. 2 is a process flow chart 200 illustrating features of a method consistent with implementations of the current subject matter. At 202, a host server displays at least one digital ticket offering available for sale onto a client device. An issuer server provides the host server with transfer parameters that must be met. At 204, the host server receives a request from the client device to purchase at least one of the digital ticket offerings. At 206, the host server changes the registered owner of the digital ticket offering from a previous owner to the purchaser, upon receipt of payment for the digital ticket offering. At 208, the host server provides data to the client device comprising the at least one digital ticket offering.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (sometimes referred to as a computer program product) refers to physically embodied apparatus and/or device, such as for example magnetic discs, optical disks, memory, and Programmable Logic Devices (PLDs), used to provide machine instructions and/or data to a programmable data processor, including a machine-readable medium that receives machine instructions as a machine-readable signal. The term “machine-readable signal” refers to any signal used to provide machine instructions and/or data to a programmable data processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. For example, the current subject matter can be implemented using row store disk databases. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A method comprising:
causing, by a host server, data characterizing a plurality of digital ticket offerings for sale to be displayed on a graphical user interface of a client device, wherein the digital ticket offerings each have a respective registered owner and can only be used by such registered owner in connection with an event or service, wherein an issuer server provides the host server with transfer parameters that must be met for the digital ticket offerings and the host server only displays each digital ticket offerings upon verification that the transfer parameters for the digital ticket offering is met;
receiving, at the host server from the client device, data comprising a request to purchase one of the displayed digital ticket offerings, the request including identification information for a purchaser;
changing, by the host server, the registered owner of the digital ticket offering specified in the request to the purchaser upon confirmation of receipt of payment for such digital ticket offering; and
providing, by the host server, data comprising the digital ticket offering.

2. The method of claim 1 wherein providing data comprises at least one of:
transmitting data to the client device enabling the digital ticket offering to be rendered in the graphical user interface of the client device, transmitting data to the client device enabling the digital ticket offering to be physically printed, storing the data, or loading the data into memory.

3. The method of claim 1 further comprising:
receiving, by the host server from a selling client device, the data characterizing at least one of the plurality of digital ticket offerings for sale prior to the displaying of the digital ticket offering on the client device, wherein the registered owner of the digital ticket offering is initially a seller associated with the selling client device, prior to the changing of the registered owner to the purchaser.

4. The method of claim 1 further comprising:
receiving, by the host server from the issuer server, the data characterizing at least one of the plurality of digital ticket offerings for sale, prior to the displaying of the digital ticket offerings on the client device, wherein the digital ticket offerings comprise at least one of unsold tickets, donor tickets, or released away tickets, prior to the changing of the registered owner to the purchaser.

5. The method of claim 4, wherein the registered owner of the digital ticket offering, prior to the changing of the registered owner to the purchaser, comprises at least one of a donor, a contingent ticket owner, or the issuer server.

6. The method of claim 1 wherein the transfer parameters are compared against parameters for each digital ticket offerings set through a selling client device, wherein the parameters for each digital ticket offering comprises at least one of price or promotion, and wherein the transfer parameters comprise at least one of a price range window within which the digital ticket offering can be offered for sale, limitations of which promotions can be included in the ticket offering, or a duration of time that the ticket can be available be for sale.

7. The method of claim 1, wherein the issuer server controls both the digital ticket offerings available for first time sale in a primary market and the digital tickets offerings available for re-sale in a secondary market.

8. The method of claim 1, wherein the changing of the registered owner of the digital ticket offering to the purchaser comprises sending a portion of the received payment to the issuer server.

9. The method of claim 1, wherein the digital ticket offerings comprise at least one of season passes, contingent digital tickets, donor ticket allotments, individual digital tickets for individual event, and promotions.

10. The method of claim 1, further comprising:
releasing, by the host server upon receiving notification of a transition action, the digital ticket offering and revoking the ability to change ownership of the digital ticket offering, wherein only the last registered owner assigned to the digital ticket offering can exercise the right promised by the digital ticket offering.

11. The method of claim 9, wherein a transition action comprises at least one of:
printing the digital ticket offering,
successful identification verification confirming that the identity of an individual attempting to enter the event corresponds with the last registered owner of the digital ticket offering, or
successful verification that the client device attempting to enter an event corresponds with last registered owner of the digital ticket offering.

12. The method of claim 10, wherein a successful identification verification of the identity of the individual comprises cross referencing at least one of a visual check of an identity card, a finger print scan, an eye scan, or a facial recognition mapping with least one of a barcode, radio frequency identifier, printed or digital picture of the individual, or the name of the individual.

13. The method of claim 10, wherein a successful verification of the client device corresponding with the last registered owner of the digital ticket offering comprises using at least one of a proximity sensor, a global positioning system, validation test messaging, a subscriber identity module, or a unique identification number corresponding to the client device.

14. A non-transitory computer program product storing instructions which, when executed by at least one data processor forming part of at least one computing system, result in operations comprising:
causing, by a host server, data characterizing a plurality of digital ticket offerings for sale to be displayed on a graphical user interface of a client device, wherein the digital ticket offerings each have a respective registered owner and can only be used by such registered owner in connection with an event or service, wherein an issuer server provides the host server with transfer parameters that must be met for the digital ticket offerings and the host server only displays each digital ticket offerings upon verification that the transfer parameters for the digital ticket offering is met;
receiving, at the host server from the client device, data comprising a request to purchase one of the displayed digital ticket offerings, the request including identification information for a purchaser;
changing, by the host server, the registered owner of the digital ticket offering specified in the request to the purchaser upon confirmation of receipt of payment for such digital ticket offering; and
providing, by the host server, data comprising the digital ticket offering.

15. The non-transitory computer program product as in claim 14, wherein providing data comprises at least one of:
transmitting data to the client device enabling the digital ticket offering to be rendered in the graphical user interface of the client device, transmitting data to the client device enabling the digital ticket offering to be physically printed, storing the data, or loading the data into memory.

16. The non-transitory computer program product as in claim 14 further comprising:
receiving, by the host server from a selling client device, the data characterizing at least one of the plurality of digital ticket offerings for sale prior to the displaying of the digital ticket offering on the client device, wherein the registered owner of the digital ticket offering is initially a seller associated with the selling client device, prior to the changing of the registered owner to the purchaser.

17. The non-transitory computer program product as in claim 14 further comprising:
receiving, by the host server from the issuer server, the data characterizing at least one of the plurality of digital ticket offerings for sale, prior to the displaying of the digital ticket offerings on the client device, wherein the digital ticket offerings comprise at least one of unsold tickets, donor tickets, or released away tickets, prior to the changing of the registered owner to the purchaser.

18. The non-transitory computer program product as in claim 17 wherein the registered owner of the digital ticket offering, prior to the changing of the registered owner to the purchaser, comprises at least one of a donor, a contingent ticket owner, or the issuer server.

19. The non-transitory computer program product as in claim 14 wherein the transfer parameters are compared against parameters for each digital ticket offerings set through a selling client device, wherein the parameters for each digital ticket offering comprises at least one of price or promotion, and wherein the transfer parameters comprise at least one of a price range window within which the digital ticket offering can be offered for sale, limitations of which promotions can be included in the ticket offering, or a duration of time that the ticket can be available be for sale.

20. The non-transitory computer program product as in claim 14 wherein the issuer server controls both the digital tickets offerings available for first time sale and the digital tickets offerings available for re-sale.
